(19) United States
(12) Patent Application Publication
(10) Pub. No.: US 2025/0208745 A1
(43) Pub. Date: Jun. 26, 2025

(54) INTERACTION CONTROL METHOD AND APPARATUS, MEDIUM, AND ELECTRONIC DEVICE

(71) Applicant: Beijing Zitiao Network Technology Co., Ltd., Beijing (CN)

(72) Inventor: Guangyuan LI, Beijing (CN)

(21) Appl. No.: 18/923,973

(22) Filed: Oct. 23, 2024

(30) Foreign Application Priority Data
Dec. 21, 2023 (CN) 202311777989.2

(51) Int. Cl. G06F 3/04815; G06F 3/0485

(52) U.S. Cl. CPC G06F 3/04815; G06F 3/0485

(57) ABSTRACT

The embodiments of the present disclosure provide an interaction control method, an interaction control apparatus, a computer-readable medium, and an electronic device. The method includes: displaying a first interaction control, the first interaction control including a plurality of axial directions for a user to select; determining at least one target axial direction in response to a selection operation for any axial direction in the plurality of axial directions; determining an array range of a first target object according to the target axial direction; and arraying and drawing, in response to a determined target array quantity, the first target object according to the target array quantity and the array range.

### CROSS-REFERENCE TO RELATED APPLICATION

This application claims the priority to and benefits of the Chinese Patent Application No. 202311777989.2, filed on Dec. 21, 2023, the entire disclosure of which is incorporated herein by reference as part of the disclosure of this application.

### TECHNICAL FIELD

The present disclosure relates to the field of computer technologies, and in particular, to an interaction control method, an interaction control apparatus, a medium, and an electronic device.

### BACKGROUND

An array function is an important function of a three-dimensional modeling software or a planar software. The array function may help users to evenly place objects in a line, a plane, or a three-dimensional space. Usually, the array function is basically configured to define a direction, an interval, and a quantity of an object array by using a table. For example, taking a ring array as an example, users need to input an array quantity and an array range in a list of the array function or perform operations such as selecting an array center point, so as to implement the ring array. However, arraying objects in this manner is often complicated, and users need to continuously set the direction, the interval, and the quantity of the array, resulting in low efficiency of the object array and poor user experience.

### SUMMARY

The embodiments of the present disclosure provide an interaction control method, an interaction control apparatus, a medium, and an electronic device.

According to a first aspect, the present disclosure provides an interaction control method, comprising:
displaying a first interaction control, wherein the first interaction control comprises a plurality of axial directions for a user to select;
determining at least one target axial direction in response to a selection operation for any axial direction in the plurality of axial directions;
determining an array range of a first target object according to the target axial direction; and
arraying and drawing, in response to a determined target array quantity, the first target object according to the target array quantity and the array range.

According to a second aspect, the present disclosure provides an interaction control apparatus, comprising:
a display module, configured to display a first interaction control, wherein the first interaction control comprises a plurality of axial directions for a user to select;
a first determination module, configured to determine at least one target axial direction in response to a selection operation for any axial direction in the plurality of axial directions;
a second determination module, configured to determine an array range of a first target object according to the target axial direction; and
a drawing module, configured to array and draw, in response to a determined target array quantity, the first target object according to the target array quantity and the array range.

According to a third aspect, the present disclosure provides a computer-readable medium, a computer program is stored on the computer-readable medium, and the computer program, when executed by a processing apparatus, causes the processing apparatus to implement steps of the method according to the first aspect.

According to a fourth aspect, the present disclosure provides an electronic device, the electronic device comprises a storage apparatus and a processing apparatus, a computer program is stored on the storage apparatus, and the processing apparatus is configured to execute the computer program on the storage apparatus to implement steps of the method according to the first aspect.

Based on the above technical solutions, a first interaction control including a plurality of axial directions is displayed, a target axial direction is determined in response to a selection operation for any axial direction in the plurality of axial directions, an array range of a first target object is determined according to the target axial direction, and in response to a determined target array quantity, the first target object is arrayed and drawn according to the target array quantity and the array range. Thus, users can quickly and easily determine the array range of the first target object through the operation for the first interaction control. Moreover, through the first interaction control, users can also intuitively understand and select the array range. Furthermore, through the first interaction control, users can repeatedly modify the target axial direction of the first target object array, so that it is convenient for users to modify the first target object array.

Other features and advantages of the present disclosure will be described in detail in the following sections.

### BRIEF DESCRIPTION OF DRAWINGS

The above and other features, advantages and aspects of the embodiments of the present disclosure are more apparent with reference to the accompanying drawings and the following specific implementations. Throughout the accompanying drawings, identical or similar reference numerals represent identical or similar elements. It should be understood that the accompanying drawings are schematic, and components and elements may not be necessarily drawn to scale.

FIG. 1 is a flowchart of an interaction control method according to at least one embodiment of the present disclosure;

FIG. 2 is a schematic diagram of an array control according to at least one embodiment of the present disclosure;

FIG. 3 is a schematic diagram of a first interaction control according to at least one embodiment of the present disclosure;

FIG. 4 is a schematic diagram of an axis and a control point according to at least one embodiment of the present disclosure;

FIG. 5 is a schematic diagram of an array according to at least one embodiment of the present disclosure;

FIG. 6 is a schematic diagram of determining a target array quantity according to at least one embodiment of the present disclosure;

FIG. 7 is a schematic diagram of displaying a target line according to at least one embodiment of the present disclosure;

FIG. 8 is a schematic structural diagram of an interaction control apparatus according to at least one embodiment of the present disclosure; and

FIG. 9 is a schematic structural diagram of an electronic device according to at least one embodiment of the present disclosure.

### DETAILED DESCRIPTION

The embodiments of the present disclosure will be described in more detail below with reference to the accompanying drawings. While certain embodiments of the present disclosure are shown in the drawings, it should be understood that the present disclosure may be embodied in various forms and should not be construed as limited to the embodiments set forth herein. Rather, these embodiments are provided for a thorough and complete understanding of the present disclosure. It should be understood that the drawings and embodiments of the present disclosure are only for exemplary purposes and are not intended to limit the protection scope of the present disclosure.

It should be understood that the various steps described in the method implementations of the present disclosure may be performed according to different orders and/or in parallel. Furthermore, the method implementations may include additional steps and/or omit performing the illustrated steps. The scope of the present disclosure is not limited in this aspect.

As used herein, the terms “include,” “comprise,” and variations thereof are open-ended inclusions, i.e., “including but not limited to.” The term “based on” is “based, at least in part, on.” The term “an embodiment” represents “at least one embodiment,” the term “another embodiment” represents “at least one additional embodiment,” and the term “some embodiments” represents “at least some embodiments.” Relevant definitions of other terms will be given in the description below.

It should be noted that concepts such as the “first,” “second,” or the like mentioned in the present disclosure are only used to distinguish different apparatuses, modules or units, and are not used to limit the interdependence relationship or the order of functions performed by these apparatuses, modules or units.

It should be noted that the modifications of “a,” “an,” “a plurality of,” and the like mentioned in the present disclosure are illustrative rather than restrictive, and those skilled in the art should understand that unless the context clearly indicates otherwise, these modifications should be understood as “one or more.”

The names of messages or information exchanged between multiple apparatuses in the implementations of the present disclosure are only for illustrative purposes, and are not intended to limit the scope of these messages or information.

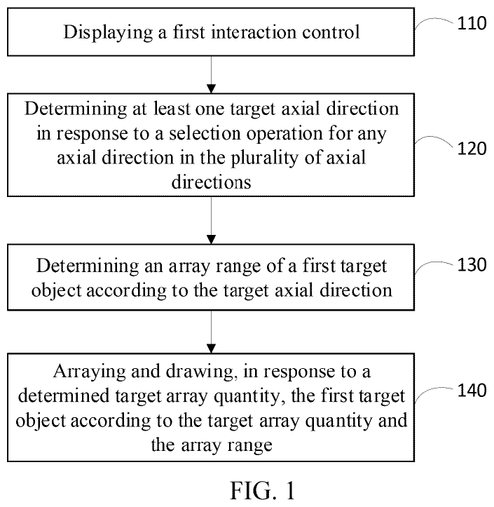

FIG. 1 is a flowchart of an interaction control method according to at least one embodiment of the present disclosure. As illustrated in FIG. 1, an embodiment of the present disclosure provides an interaction control method, the method may be performed by an electronic device, specifically performed by an interaction control apparatus, and the apparatus may be implemented in a software and/or hardware manner and configured in the electronic device. As illustrated in FIG. 1, the method may include the following steps.

Step 110: displaying a first interaction control.

Here, the first interaction control may be displayed in a graphical user interface corresponding to the three-dimensional modeling software or planar graphics software.

For example, the first interaction control may be displayed in the graphical user interface when the user activates an array function for the first target object.

For example, when the user selects the first target object in the graphical user interface and activates the array function, the first interaction control is displayed in the graphical user interface. It should be understood that the first target object may refer to a virtual item created in the graphical user interface.

The first interaction control includes a plurality of axial directions for the user to select. It should be understood that the axial direction refers to a direction in which the first target object is arrayed. In the first interaction control, the plurality of axial directions for the user to select may be displayed. A quantity of the plurality of axial directions may be determined according to an application scenario of the array function.

For example, if arraying is performed in a three-dimensional virtual scene, the plurality of axial directions are an X axis, a Y axis, and a Z axis of the three-dimensional virtual scene. If arraying is performed in a two-dimensional scene, the plurality of axial directions are an X axis and a Y axis of the two-dimensional scene.

Step 120: determining at least one target axial direction in response to a selection operation for any axial direction in the plurality of axial directions.

Here, the user may select any quantity of axial directions from the plurality of axial directions provided by the first interaction control as the target axial direction through the selection operation for the axial direction.

For example, assuming that the plurality of axial directions include an X axis, a Y axis and a Z axis, if the user selects the X axis from the X axis, the Y axis and the Z axis through the selection operation, the X axis serves as the target axial direction; if the user selects the X axis and the Z axis from the X axis, the Y axis and the Z axis through the selection operation, the X axis and the Z axis serve as the target axial direction; and if the user selects the X axis, the Y axis and the Z axis from the X axis, the Y axis and the Z axis through the selection operation, the X axis, the Y axis and the Z axis serve as the target axial direction.

Step 130: determining an array range of a first target object according to the target axial direction.

Here, the array range refers to a shape and a size of a region in which the first target object is arrayed. For example, assuming that rectangular arraying is performed, the corresponding rectangle is the array range of the first target object. For another example, assuming that curve arraying is performed, the corresponding curve is the array range of the first target object. For still another example, assuming that spatial arraying is performed, the corresponding three-dimensional space is the array range of the first target object.

It should be understood that each axial direction may not only have a default indicating direction, but also may have a default axial length with a fixed length value. That is, each axial direction has not only a corresponding indicating direction, but also a corresponding axial length. Certainly, the user may also customize and set the axial length corresponding to each axial direction.

For example, the array range of the first target object may be determined according to a direction indicated by the target axial direction and an axial length corresponding to the target axial direction.

For example, a region surrounded by the direction indicated by the target axial direction and the axial length corresponding to the target axial direction may be used as the array range of the first target object.

For example, if the target axial direction is the X axis, a region corresponding to an indicating direction and an axial length of the X axis is the array range of the first target object. For another example, if the target axial direction is the X axis and the Z axis, a planar region surrounded by an indicating direction and an axial length of the X axis, and an indicating direction and an axial length of the Y axis is the array range of the first target object. For still another example, if the target axial direction is the X axis, the Y axis and the Z axis, a three-dimensional space region surrounded by an indicating direction and an axial length of the X axis, an indicating direction and an axial length of the Y axis, and an indicating direction and an axial length of the Z axis is the array range of the first target object.

Therefore, the array range of the first target object may be determined by the target axial direction selected by the user, so that the array range of the first target object is determined intuitively.

It should be noted that the axial direction may extend axially with the first target object as a coordinate origin. That is, the finally-determined array range of the first target object may be constructed by using the first target object as the coordinate origin.

Step 140: arraying and drawing, in response to a determined target array quantity, the first target object according to the target array quantity and the array range.

Here, the target array quantity may refer to a quantity of first target objects that the user needs to array and draw. Taking rectangular arraying as an example, the target array quantity may refer to a quantity of the first target objects corresponding to each row or each column within a rectangular range corresponding to the rectangular arraying. It should be noted that calculation of the target array quantity may include the original first target object.

It should be understood that the target array quantity may be input by the user. Certainly, the target array quantity for arraying the first target object may also be a default value. Exemplarily, the user may determine the target array quantity through a sliding operation on the graphical user interface. The specific determination method for the target array quantity will be described in detail in following implementations.

Arraying and drawing the first target object according to the target array quantity and the array range means drawing the target array quantity of first target objects at an equal interval within the array range. For example, the spacing between the first target objects drawn at the equal interval may be determined according to the target array quantity and the array range.

Therefore, by displaying a first interaction control including a plurality of axial directions, determining at least one target axial direction in response to a selection operation for any axial direction in the plurality of axial directions, determining an array range of a first target object according to the target axial direction, and arraying and drawing, in response to a determined target array quantity, the first target object according to the target array quantity and the array range, the user can quickly and easily determine the array range of the first target object through the operation for the first interaction control, and the user can also intuitively understand and select the array range through the first interaction control. Furthermore, through the first interaction control, the user can repeatedly modify the target axial direction of the first target object array, so that it is convenient for the user to modify the first target object array.

In some implementations, an array control may be displayed in response to a selection operation for the first target object, and the first interaction control may be displayed in response to a selection operation for the array control.

Here, the array control is a control used for triggering the array function, and the array control may be a button. The selection operation for the first target object may refer to that the user clicks on the first target object. When the user clicks on the first target object in the graphical user interface, the array control is displayed in an adjacent region of the first target object.

When it is detected that the selection operation for the array control is performed, it indicates that the user needs to perform an array operation on the first target object. In this case, the first interaction control may be displayed in an adjacent region of the array control. For example, the selection operation for the array control may refer to that the user clicks on the array control.

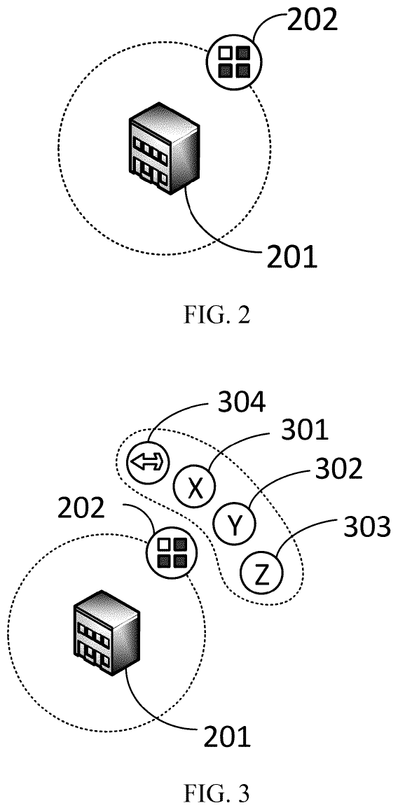

FIG. 2 is a schematic diagram of an array control according to at least one embodiment of the present disclosure. As illustrated in FIG. 2, when the user selects a first target object 201, a corresponding array control 202 may be displayed in an adjacent region of the first target object 201. It should be understood that a dotted circle in FIG. 2 represents that the first target object 201 is in a selected state. Certainly, in specific implementation, in addition to display of the array control 202, a control used for triggering other functions may also be displayed.

Therefore, the array function for the first target object may be quickly triggered through the array control described above.

In some implementations, when the first target object is an object obtained by arraying a second target object in a virtual scene, in response to a selection operation for the first target object, the array control is displayed at the second target object corresponding to the first target object, and the first target object obtained by arraying the second target object is deleted.

Here, the first target object may be an object obtained by arraying the second target object in the virtual scene. As illustrated in FIG. 5, the first target object 201 (equivalent to the second target object) in the virtual scene is arrayed to obtain nineteen other objects (equivalent to the first target objects) consistent with the first target object 201.

That is, after the user controls the second target object in the virtual scene to be arrayed to obtain multiple first target objects, if the user needs to modify the array generated based on the second target object, the user may trigger the selection operation for the first target object. Correspondingly, the array control is displayed at the second target object corresponding to the first target object, and the first target object obtained by arraying the second target object is deleted.

As illustrated in FIG. 5, when the user selects another object other than the first target object 201 and triggers an array modification operation, it indicates that the user needs to modify the array generated based on the first target object 201. Correspondingly, the array control 202 is displayed at the first target object 201, and other objects obtained by arraying the first target object 201 are deleted.

Therefore, through the above implementations, the user can quickly modify the array after completing the array, without the need to delete the objects obtained by the array one by one, and the user can initiate a new array function again, thereby greatly improving the modeling efficiency for the user.

In some implementations, the plurality of axial directions may include a first axial direction, a second axial direction, and a third axial direction, and a virtual scene in which the first target object is located is constructed through the first axial direction, the second axial direction, and the third axial direction.

It should be understood that the virtual scene in which the first target object is located is a three-dimensional space constructed by using a coordinate system composed of the first axial direction, the second axial direction, and the third axial direction. For example, the first axial direction, the second axial direction, and the third axial direction are perpendicular to each other pairwise. Exemplarily, the first axial direction may be an X axis in a three-dimensional coordinate system, the second axial direction may be a Y axis in the three-dimensional coordinate system, and the third axial direction may be a Z axis in the three-dimensional coordinate system.

Correspondingly, the first interaction control includes a first sub-control representing the first axial direction, a second sub-control representing the second axial direction, and a third sub-control representing the third axial direction.

The electronic device may determine the target axial direction in response to a selection operation for any sub-control among the first sub-control, the second sub-control, and the third sub-control.

For example, the selection operation for any sub-control among the first sub-control, the second sub-control, and the third sub-control may be a click operation for any sub-control. Moreover, the user may select one or more sub-controls among the first sub-control, the second sub-control, and the third sub-control.

FIG. 3 is a schematic diagram of a first interaction control according to at least one embodiment of the present disclosure. As illustrated in FIG. 3, when the user clicks on the array control 202, the first interaction control may be displayed in an adjacent region of the array control 202. The first interaction control includes a first sub-control 301 representing the first axial direction, a second sub-control 302 representing the second axial direction, and a third sub-control 303 representing the third axial direction. The user may determine, by selecting one or more sub-controls among the first sub-control 301, the second sub-control 302, and the third sub-control 303, an axial direction corresponding to the selected sub-control as the target axial direction.

It should be noted that the first interaction control shown in FIG. 3 is merely an example and is not used to limit the shape, appearance, or the like of the first interaction control provided by the embodiments of the present disclosure. Moreover, the first interaction control in FIG. 3 includes the first sub-control 301 representing the first axial direction, the second sub-control 302 representing the second axial direction, and the third sub-control 303 representing the third axial direction, which are set in the case that the virtual scene in which the first target object 201 is located is a three-dimensional space. If the virtual scene in which the first target object 201 is located is a two-dimensional plane, the first interaction control may include the first sub-control 301 representing the first axial direction and the second sub-control 302 representing the second axial direction.

Thus, through the first sub-control, the second sub-control, and the third sub-control, the user can quickly select the corresponding target axial direction, so that it is convenient for the user to use the array function for the first target object, thereby greatly improving the modeling efficiency for the user as well as the user experience.

In some implementations, the electronic device may display an axis of the target axial direction and a control point used for adjusting the axis in response to an adjusting operation for the target axial direction, move the control point to obtain a new axis in response to a moving operation for the control point, and then determine a new target axial direction according to the new axis.

Here, the adjusting operation for the target axial direction may be an adjustment operation for one or more axial directions included in the target axial direction. When the target axial direction includes one axial direction, if it is detected that the adjusting operation for the target axial direction is performed, the control point and the axis of the axial direction are displayed. When the target axial direction includes a plurality of axial directions, if it is detected that an adjusting operation for any axial direction in the target axial direction is performed, the control point and the axis of the axial direction for which the adjusting operation is performed are displayed. Certainly, when the target axial direction includes a plurality of axial directions, if it is detected that the adjusting operation for the target axial direction is performed, the control points and the axes of all the axial directions may also be displayed.

For example, the adjusting operation for the target axial direction may be triggered by using an adjustment control. As shown in FIG. 3, while the first sub-control 301, the second sub-control 302, and the third sub-control 303 are displayed, an adjustment control 304 may also be displayed. When the user clicks on the adjustment control 304, the adjusting operation for the target axial direction may be triggered, and the control point and the axis corresponding to the target axial direction are displayed.

Certainly, the adjusting operation for the target axial direction may also be triggered in other manners. For example, the user may click on the corresponding axial direction to trigger the display of the control point and the axis of the target axial direction.

It should be noted that the control point of the axis may be used to adjust at least one of an indicating direction, a length, and a shape of the axis. Exemplarily, the shape, the length, and the indicating direction of the axis may be controlled by using multiple control points, and the user may adjust a position of one or more of the multiple control points, so as to adjust at least one of the shape, the length, and the indicating direction of the axis.

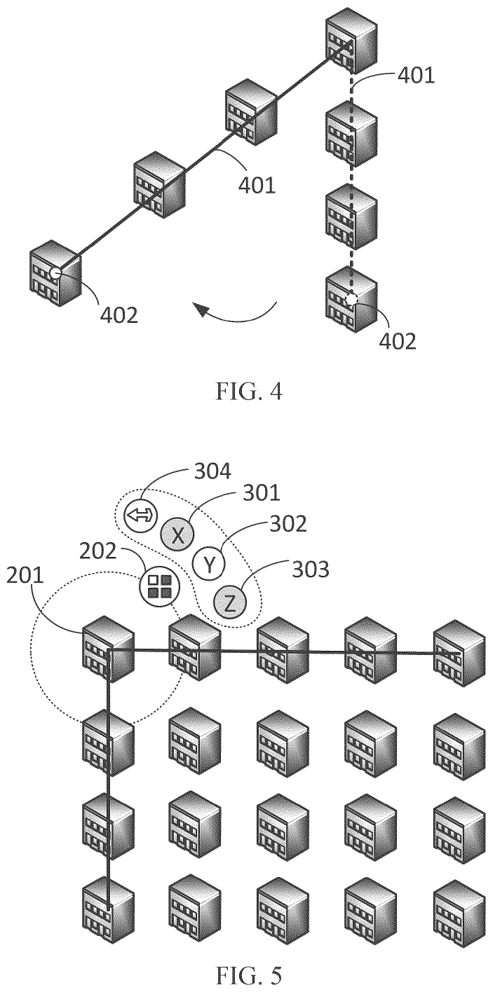

FIG. 4 is a schematic diagram of an axis and a control point according to at least one embodiment of the present disclosure. As illustrated in FIG. 4, when the user clicks on the adjustment control 304 in FIG. 3, the control point 402 and the axis 401 of the target axial direction are displayed. Then, the control point 402 is moved in response to a moving operation of the user for the control point 402. Correspondingly, the length and the indicating direction of the axis 401 are changed so as to obtain a new axis 402. The new axis 402 is configured to be the new target axial direction.

In some examples, the user may directly drag the control point 402 to move the control point 402. Certainly, in other examples, the user may also move the control point 402 by using a control corresponding to the control point 402. That is, when the control point 402 is displayed, the control corresponding to the control point 402 may also be displayed, and the user may drag the control to move the control point 402.

It should be noted that the axis and the control point shown in FIG. 4 are merely used as an example to illustrate the above implementations. In the practical application process, the control point of the axis may be used to adjust at least one of an indicating direction, a length, and a shape of the axis. That is, the control point of the axis may include not only one control point, but also multiple control points.

It should be understood that the user may move the control point freely in the virtual scene to adjust the axis of the target axial direction. That is, the moving distance and moving direction of the control point may not be limited.

For example, the new axis is obtained by moving the control point, and the new axis is used as the new target axial direction. The electronic device may re-determine the array range based on the new target axial direction.

Therefore, by displaying the control point and the axis of the target axial direction, the user can quickly, intuitively, and conveniently adjust the array range of the arraying for the first target object, thereby improving the efficiency of arraying and improving the user experience.

In some implementations, when the target axial direction includes any one axial direction among the first axial direction, the second axial direction, and the third axial direction, the array range is determined according to the any one axial direction.

In some implementations, when the target axial direction includes any two axial directions among the first axial direction, the second axial direction, and the third axial direction, the array range is determined according to a planar range surrounded by the any two axial directions.

In some implementations, when the target axial direction includes the first axial direction, the second axial direction, and the third axial direction, the array range is determined according to a spatial range surrounded by the first axial direction, the second axial direction, and the third axial direction.

Here, if the user selects any axial direction among the first axial direction, the second axial direction, and the third axial direction as the target axial direction, the direction indicated by the target axial direction and the axial length corresponding to the target axial direction are configured to be the corresponding array range.

For example, if the target axial direction is the X axis, a region corresponding to the indicating direction and the axial length of the X axis is the array range of the first target object.

If the user selects any two axial directions among the first axial direction, the second axial direction, and the third axial direction as the target axial direction, a planar region surrounded by the directions indicated by the any two axial directions and the axial lengths corresponding to the any two axial directions is the corresponding array range.

For example, if the target axial direction is the X axis and the Z axis, a planar region surrounded by the indicating direction and the axial length of the X axis, and the indicating direction and the axial length of the Y axis is the array range of the first target object.

It should be understood that a planar region surrounded by the directions indicated by the any two axial directions and the axial lengths corresponding to the any two axial directions is the corresponding array range, which may refer to that a region of a planar quadrilateral surrounded by the directions indicated by the any two axial directions and the axial lengths corresponding to the any two axial directions is the corresponding array range.

If the user selects the first axial direction, the second axial direction, and the third axial direction as the target axial direction, a three-dimensional space region surrounded by the directions indicated by the first axial direction, the second axial direction, and the third axial direction, and the axial lengths corresponding to the first axial direction, the second axial direction, and the third axial direction is the corresponding array range.

For example, if the target axial direction is the X axis, the Y axis, and the Z axis, a three-dimensional space region surrounded by the indicating direction and the axial length of the X axis, the indicating direction and the axial length of the Y axis, and the indicating direction and the axial length of the Z axis is the array range of the first target object.

Therefore, the array range corresponding to the first target object can be quickly determined through the target axial direction selected by the user.

FIG. 5 is a schematic diagram of an array according to at least one embodiment of the present disclosure. As illustrated in FIG. 5, when the user selects a first target object 201, a corresponding array control 202 is displayed in an adjacent region of the first target object 201. When the user clicks on the array control 202, a first sub-control 301, a second sub-control 302, and a third sub-control 303 are displayed in an adjacent region of the array control 202. The user determines the corresponding array range by clicking on any sub-control among the first sub-control 301, the second sub-control 302, and the third sub-control 303.

In FIG. 5, the user selects the first sub-control 301 (the X axis) and the third sub-control 303 (the Z axis) as the target axial direction. That is, in FIG. 5, arraying is performed by using a planar region surrounded by the X axis corresponding to the first sub-control 301 and the Z axis corresponding to the third sub-control 303 as the array range. In this case, the target array quantity corresponding to the arraying may be specified by the user or pre-configured.

In some implementations, in response to a sliding operation for any axial direction in the target axial direction, a target array quantity in the any axial direction may be determined according to a sliding direction and a sliding distance of the sliding operation.

Here, the sliding operation for any axial direction in the target axial directions may be a sliding operation for one or more axial directions in the target axial directions. For example, if the first axial direction, the second axial direction, and the third axial direction are used as the target axial directions, the sliding operation for any axial direction in the target axial directions may refer to a sliding operation for any axial direction among the first axial direction, the second axial direction, and the third axial direction.

For example, the user may select any axial direction in the target axial directions as an axial direction for which the target array quantity needs to be determined. Then, the target array quantity is determined through the sliding operation of the user. The sliding operation may be sent out by the user by using a mouse or through a touch action.

It should be understood that the sliding operation for any axial direction is used to determine the target array quantity, and does not change the direction, the axial length, the shape, or the like of the axial direction itself.

When it is detected that the sliding operation for any axial direction in the target axial directions is performed, the electronic device determines the target array quantity in the any axial direction according to the sliding direction and the sliding distance of the sliding operation.

For example, the target array quantity may include an increased array quantity or a reduced array quantity. The value corresponding to the target array quantity may be proportional to the sliding distance corresponding to the sliding operation. That is, the larger the sliding distance corresponding to the sliding operation is, the larger the value corresponding to the target array quantity is; and the smaller the sliding distance corresponding to the sliding operation is, the smaller the value corresponding to the target array quantity is. The sliding direction corresponding to the sliding operation determines whether the array quantity is increased or reduced.

Thus, the target array quantity is determined through the sliding operation for any axial direction in the target axial directions, so that the user can quickly and conveniently adjust the target array quantity in the any axial direction, thereby improving the efficiency of using the array function.

In some embodiments, in response to the sliding operation for a second interaction control corresponding to any axial direction in the target axial directions, the electronic device may determine the target array quantity in the any axial direction according to the sliding direction and the sliding distance of the sliding operation.

Here, the second interaction control may be the first sub-control 301, the second sub-control 302, and the third sub-control 303 provided in the above embodiments. That is, after the user determines the target axial direction by clicking on any sub-control among the first sub-control 301, the second sub-control 302, and the third sub-control 303, the user may also perform a sliding operation on the selected any sub-control, so as to determine the target array quantity according to the sliding direction and the sliding distance of the sliding operation.

For example, the user may trigger the function of adjusting the target array quantity by clicking on or long-pressing the corresponding second interaction control. For example, the user may long-press the second interaction control, and then perform the sliding operation to trigger the determination of the target array quantity according to the sliding direction and the sliding distance of the sliding operation.

It should be understood that the second interaction control may move along with the sliding operation, that is, the user may determine the target array quantity by dragging the second interaction control. Certainly, the second interaction control may also not move along with the sliding operation, that is, when the user long-presses the second interaction control and then performs the sliding operation, the second interaction control does not move along with the movement of the sliding operation, but is fixed at the original position.

Thus, the sliding operation is performed on the second interaction control, so that the user can quickly and conveniently adjust the target array quantity in any axial direction, thereby improving the efficiency of using the array function.

In some implementations, when the sliding direction of the sliding operation is a first direction, the electronic device may determine to increase the array quantity in any axial direction, and determine, according to the sliding distance corresponding to the sliding operation and in combination with a mapping relationship between the sliding distance and the array quantity, a target array quantity to be increased in the any axial direction; and when the sliding direction of the sliding operation is a second direction, the electronic device may determine to reduce the array quantity in any axial direction, and determine, according to the sliding distance corresponding to the sliding operation and in combination with a mapping relationship between the sliding distance and the array quantity, a target array quantity to be reduced in the any axial direction.

Here, the second direction is an opposite direction of the first direction. Exemplarily, the first direction may refer to a direction away from the second interaction control, and the second direction may refer to a direction close to the second interaction control. That is, when the sliding direction of the sliding operation is a direction gradually away from the second interaction control, the sliding direction of the sliding operation is the first direction; and when the sliding direction of the sliding operation is a direction gradually close to the second interaction control, the sliding direction of the sliding operation is the second direction.

When the sliding direction corresponding to the sliding operation for any axial direction in the target axial directions is the first direction, it indicates to increase the array quantity of the first target object in the any axial direction. When the sliding direction corresponding to the sliding operation for any axial direction in the target axial directions is the second direction, it indicates to reduce the array quantity of the first target object in the any axial direction.

The increased or reduced array quantity is obtained according to the sliding distance corresponding to the sliding operation and in combination with the mapping relationship between the sliding distance and the array quantity, and the target array quantity finally obtained is the reduced array quantity in the any axial direction or the increased array quantity in the any axial direction.

For example, the mapping relationship between the sliding distance and the array quantity may refer to that the sliding distance is proportional to the array quantity. That is, the larger the sliding distance corresponding to the sliding operation is, the larger the value corresponding to the target array quantity is; and the smaller the sliding distance corresponding to the sliding operation is, the smaller the value corresponding to the target array quantity is. The sliding direction corresponding to the sliding operation determines whether the array quantity is increased or reduced.

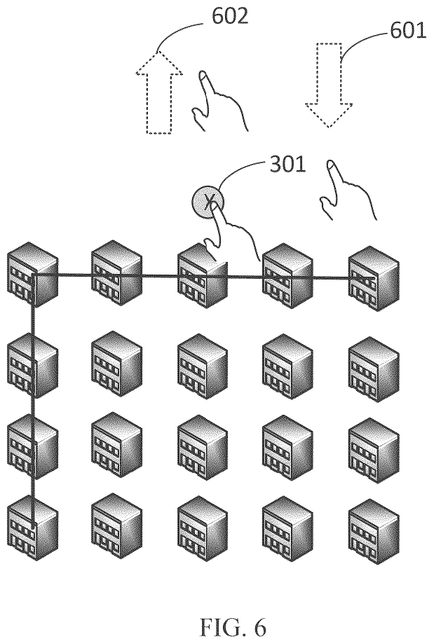

FIG. 6 is a schematic diagram of determining a target array quantity according to at least one embodiment of the present disclosure. As illustrated in FIG. 6, the second interaction control may be the first sub-control 301. The user may long-press the first sub-control 301, and then slide to a first position in a first direction 602, so as to increase the array quantity of the X axis corresponding to the first sub-control 301. Then, the user may also slide from the first position in a second direction 601, so as to reduce the array quantity of the X axis corresponding to the first sub-control 301.

Therefore, through the above implementation, the user can quickly and conveniently adjust the target array quantity in any axial direction, thereby improving the efficiency of using the array function.

In some implementations, for Step 140, the first target object may be arrayed and drawn by using an instancing method of a graphics processor.

Here, the instancing method of the graphics processor (e.g., graphics processing unit, GPU) is used to combine a large number of similar objects (such as trees, grass, etc.) into a single mesh and draw it once when rendering.

In the implementations of the present disclosure, the first target object may be arrayed and drawn by using the instancing method of the graphics processor according to the target array quantity and the array range.

Since the instancing method of the graphics processor may render multiple mesh instances (e.g., first target object) at a time, it avoids the need to separately execute a rendering instruction for each mesh entity, so that when a large quantity of first target objects are drawn, the drawing speed can be improved, and a stuck sense can be avoided. Especially when the first target objects are arrayed and drawn on a mobile terminal, through the instancing method of the graphics processor, a large quantity of first target objects can be quickly drawn, thereby improving the smoothness for the user using the array function on the mobile terminal.

It should be noted that the first target objects arrayed and drawn by using the instancing method of the graphics processor may be understood as one instance. After the array is completed, the user may also convert the arrayed instance into a single entity, and the attribute of the entity is consistent with that of the first target object.

In some implementations, when a third target object intersects with a fourth target object in the virtual scene, a fifth target object is obtained according to the third target object and the fourth target object.

Here, the third target object is an object obtained by arraying the first target object. The fourth target object refers to an object existing in the virtual scene, and the fourth target object may be an object set by the user in the virtual scene, or an object obtained by arraying other objects in the virtual scene. That the third target object intersects with the fourth target object in the virtual scene may mean that the third target object partially or completely coincides with the fourth target object.

Certainly, in some embodiments, it may be determined that the third target object intersects with the fourth target object in the virtual scene when a coincidence part between the third target object and the fourth target object in the virtual scene is greater than or equal to a preset threshold.

When the first target object is arrayed, if the third target object obtained by arraying intersects with the fourth target object in the virtual scene, the fifth target object may be obtained according to the third target object and the fourth target object.

In some embodiments, obtaining the fifth target object according to the third target object and the fourth target object may be to combine the third target object and the fourth target object into one fifth target object. That is, when the first target object is arrayed, if the third target object obtained by arraying intersects with the fourth target object in the virtual scene, the third target object and the fourth target object may be combined into one fifth target object.

Certainly, in the case that the third target object and the fourth target object are objects that can be combined, the third target object and the fourth target object may also be combined into one fifth target object. For example, whether the third target object and the fourth target object can be combined may be determined according to object types corresponding to the third target object and the fourth target object.

Therefore, through the above implementations, the third target object and the fourth target object that can be combined may be combined during the arraying process, thereby improving the modeling efficiency.

It should be noted that the obtained fifth target object may also be arrayed. That is, when the user selects the obtained fifth target object for arraying, the obtained fifth target object may also be arrayed through the interaction control method provided by the embodiments of the present disclosure.

In some implementations, in response to the first target object which is obtained by arraying and drawing reaching a preset condition, a target line is displayed on the first target object, which is obtained by arraying and drawing, according to an overall shape of the first target object. For example, the target line is used to indicate the user to set an object along the target line.

Here, the first target object which is obtained by arraying and drawing refers to other first target objects obtained by arraying the first target object in the virtual scene. As shown in FIG. 5, all the other objects other than the first target object 201 belong to the first target object which is obtained by arraying and drawing.

For example, the first target object which is obtained by arraying and drawing reaching the preset condition may be that the number of the first target objects which are obtained by arraying and drawing reaches a preset quantity threshold, and/or the first target object which is obtained by arraying and drawing reaching the preset condition may be that a shape of the obtained first target object is a preset shape.

It should be noted that the preset quantity threshold may be set according to the actual situation, or the preset quantity threshold may be dynamically set according to other objects in the virtual scene.

In the case that the first target object which is obtained by arraying and drawing reaches the preset condition, the electronic device may display the target line on the obtained first target object according to the overall shape of the obtained first target object, so as to indicate the user to set other objects along the target line through the displayed target line.

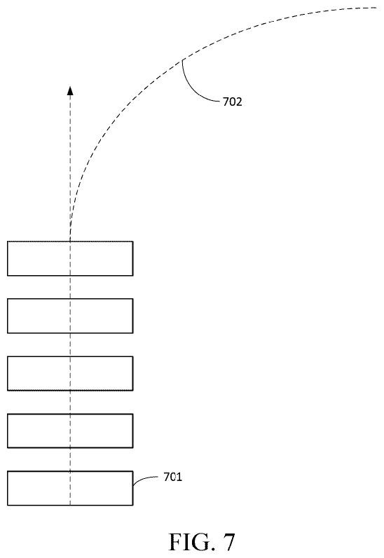

FIG. 7 is a schematic diagram of displaying a target line according to at least one embodiment of the present disclosure. As illustrated in FIG. 7, the first target object 701 is arrayed in a height direction of the virtual scene, and a plurality of first target objects are obtained by arraying and drawing. In the case that the plurality of first target objects which are obtained by arraying and drawing reach a preset condition, a target line 702 is displayed on the last first target object which is obtained by arraying and drawing.

It should be noted that the displayed target line may be used to indicate to perform arraying by using the target line as a target axial direction. That is, the user may use the target line as a new target axial direction to perform arraying on the last first target object. Certainly, the target line may be used to indicate the user to set other objects in the direction indicated by the target line.

Therefore, by displaying the target line, the user can be guided to better set an object in the virtual scene, thereby improving the modeling efficiency and ensuring the interaction experience of the user.

In some implementations, in response to a distance between two adjacent first target objects which are obtained by arraying and drawing being less than a preset distance threshold along the target axial direction, a shape or a distance of the first target object is adjusted, so as to enable the adjusted first target objects to form a whole.

Here, as shown in FIG. 7, a first target object 701 and a first target object 703 are two adjacent first target objects which are obtained by arraying and drawing. The first target object 703 and the first target object 704 are two adjacent first target objects which are obtained by arraying and drawing.

In the case that the distance between the two adjacent first target objects which are obtained by arraying and drawing is less than the preset distance threshold along the target axial direction, the shape or the distance of the two adjacent first target objects is adjusted, so as to enable the adjusted first target objects to form a whole.

For example, if a distance between the first target object 701 and the first target object 703 is less than the preset distance threshold, the shape or the distance of the first target object 701 and the first target object 703 may be adjusted, so that the adjusted first target object 701 and first target object 703 are combined to form a whole.

It should be noted that the shape or the distance of the two adjacent first target objects may be adjusted, and a distance between the adjusted two adjacent first target objects along the target axial direction may be less than or equal to a target threshold. The target threshold may be zero. Certainly, the target threshold may also be set according to the actual situation.

Taking generation of arraying floor tiles in the virtual scene as an example, the user may array and generate, based on one floor tile, a plurality of floor tiles in the target axial direction. When a distance between two adjacent floor tiles in the generated floor tiles is less than a preset distance threshold, the distance or shape of the two adjacent floor tiles may be adjusted so as to enable the two adjacent floor tiles to be combined into a whole.

Therefore, through the above implementations, the items generated through arraying by the user can be finely adjusted, thereby better assisting the user in modeling.

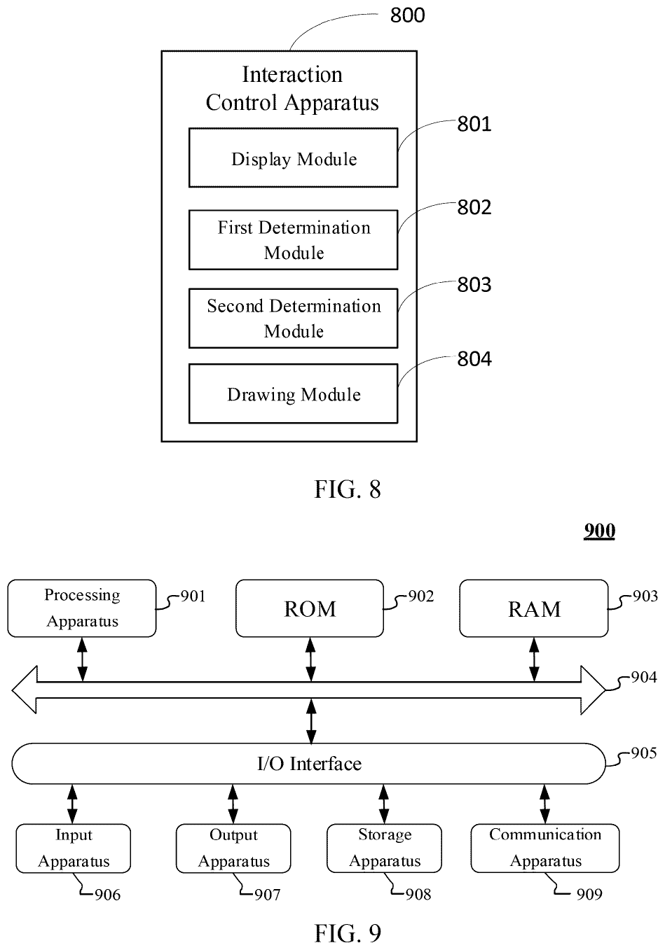

FIG. 8 is a schematic structural diagram of an interaction control apparatus according to at least one embodiment of the present disclosure. As illustrated in FIG. 8, the embodiments of the present disclosure provide an interaction control apparatus 800, and the interaction control apparatus 800 includes:
a display module 801, configured to display a first interaction control, the first interaction control including a plurality of axial directions for a user to select;
a first determination module 802, configured to determine at least one target axial direction in response to a selection operation for any axial direction in the plurality of axial directions;
a second determination module 803, configured to determine an array range of a first target object according to the target axial direction; and
a drawing module 804, configured to array and draw, in response to a determined target array quantity, the first target object according to the target array quantity and the array range.

Optionally, the drawing module 804 includes:
a determination unit, configured to determine, in response to a sliding operation for any axial direction in the target axial direction, a target array quantity in the any axial direction in the target axial direction according to a sliding direction and a sliding distance of the sliding operation.

Optionally, the determination unit is specifically configured to:
determine, in response to the sliding operation for a second interaction control corresponding to any axial direction in the target axial direction, the target array quantity in the any axial direction in the target axial direction according to the sliding direction and the sliding distance of the sliding operation.

Optionally, the determination unit is specifically configured to:
in response to the sliding direction of the sliding operation being a first direction, determine to increase an array quantity in the any axial direction in the target axial direction, and determine, according to the sliding distance corresponding to the sliding operation, a target array quantity to be increased in the any axial direction in the target axial direction in combination with a mapping relationship between the sliding distance and the array quantity; and
in response to the sliding direction of the sliding operation being a second direction, determine to reduce an array quantity in the any axial direction in the target axial direction, and determine, according to the sliding distance corresponding to the sliding operation, a target array quantity to be reduced in the any axial direction in the target axial direction in combination with a mapping relationship between the sliding distance and the array quantity, wherein the second direction is opposite to the first direction.

Optionally, the plurality of axial directions include a first axial direction, a second axial direction, and a third axial direction, a virtual scene in which the first target object is located is constructed through the first axial direction, the second axial direction, and the third axial direction, and the first interaction control comprises a first sub-control representing the first axial direction, a second sub-control representing the second axial direction, and a third sub-control representing the third axial direction; and
the first determination module 802 is specifically configured to:
determine the target axial direction in response to a selection operation for any sub-control among the first sub-control, the second sub-control, and the third sub-control.

Optionally, the plurality of axial directions include a first axial direction, a second axial direction, and a third axial direction, and a virtual scene in which the first target object is located is constructed through the first axial direction, the second axial direction, and the third axial direction; and
the second determination module 803 is specifically configured to:
in response to the target axial direction including any one axial direction among the first axial direction, the second axial direction, and the third axial direction, determine the array range according to the any one axial direction;
in response to the target axial direction including any two axial directions among the first axial direction, the second axial direction, and the third axial direction, determine the array range according to a planar range surrounded by the any two axial directions; and
in response to the target axial direction including the first axial direction, the second axial direction, and the third axial direction, determine the array range according to a spatial range surrounded by the first axial direction, the second axial direction, and the third axial direction.

Optionally, the interaction control apparatus 800 further includes:
a control point unit, configured to display an axis of the target axial direction and a control point for adjusting the axis in response to an adjusting operation for the target axial direction;
a moving unit, configured to, in response to a moving operation for the control point, move the control point to obtain a new axis; and
an axial determination unit, configured to determine a new target axial direction according to the new axis.

Optionally, the display module 801 is specifically configured to:
display an array control in response to a selection operation for the first target object; and
display the first interaction control in response to a selection operation for the array control.

Optionally, the display module 801 is specifically configured to:
in a case of the first target object being an object obtained by arraying a second target object in a virtual scene, in response to the selection operation for the first target object, display the array control at the second target object corresponding to the first target object, and delete the first target object obtained by arraying the second target object.

Optionally, the drawing module 804 is specifically configured to:
array and draw the first target object through an instancing method of a graphics processor.

Optionally, the interaction control apparatus 800 further includes:
a combination module, configured to, in response to a third target object intersecting with a fourth target object in a virtual scene, obtain a fifth target object according to the third target object and the fourth target object, the third target object being an object obtained by arraying the first target object.

Optionally, the interaction control apparatus 800 further includes:
a line display module, configured to, in response to the first target object obtained through arraying and drawing satisfying a preset condition, display a target line on the first target object obtained through arraying and drawing according to an overall shape of the first target object obtained through arraying and drawing, the target line being used to instruct the user to set an object along the target line.

Optionally, the interaction control apparatus 800 further includes:
an adjusting module, configured to, in response to a distance between two adjacent first target objects obtained through arraying and drawing in the target axial direction being less than a preset distance threshold, adjust a shape of the first target object or the distance to enable the adjusted first target objects to form a whole.

The functional logic executed by each functional module in the above interaction control apparatus 800 has been described in detail in the part regarding the method, which is not described herein again.

Hereinafter, referring to FIG. 9, it shows a schematic structural diagram of an electronic device (e.g., a terminal device or a server) 900 suitable for implementing the embodiments of the present disclosure. The terminal device in the embodiments of the present disclosure may include, but not limited to, mobile terminals, such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), etc., and fixed terminals, such as a digital television (TV), a desktop computer, etc. The electronic device shown in FIG. 9 is merely an example and should not impose any limitations on the functions and scope of use of the embodiments of the present disclosure.

As illustrated in FIG. 9, the electronic device 900 may include a processing apparatus 901 (e.g., a central processing unit, a graphics processing unit, etc.), which may execute various appropriate actions and processing according to a program stored on a read-only memory (ROM) 902 or a program loaded from a storage apparatus 908 into a random access memory (RAM) 903. The RAM 903 further stores various programs and data required for operation of the electronic device 900. The processing apparatus 901, the ROM 902, and the RAM 903 are connected with each other through a bus 904. An input/output (I/O) interface 905 is also connected to the bus 904.

Usually, apparatuses below may be connected to the I/O interface 905: an input apparatus 906 including, for example, a touch screen, a touch pad, a keyboard, a mouse, a camera, a microphone, an accelerometer, a gyroscope, or the like; an output apparatus 907 including, for example, a liquid crystal display (LCD), a speaker, a vibrator, or the like; a storage apparatus 908 including, for example, a magnetic tape, a hard disk, or the like; and a communication apparatus 909. The communication apparatus 909 may allow the electronic device 900 to perform wireless or wired communication with other devices so as to exchange data. Although FIG. 9 shows the electronic device 900 having various apparatuses, it should be understood that it is not required to implement or have all the apparatuses illustrated, and the electronic device may alternatively implement or have more or fewer apparatuses.

Specifically, according to the embodiments of the present disclosure, the process described above with reference to the flowchart may be implemented as a computer software program. For example, the embodiments of the present disclosure include a computer program product, including a computer program carried on a computer-readable medium, and the computer program includes program codes for executing the method shown in the flowchart. In such embodiments, the computer program may be downloaded and installed from the network via the communication apparatus 909, or installed from the storage apparatus 908, or installed from the ROM 902. When executed by the processing apparatus 901, the computer program may implement the above functions defined in the method provided by the embodiments of the present disclosure.

It should be noted that the computer-readable medium described in the present disclosure may be a computer-readable signal medium or a computer-readable storage medium, or any combination thereof. The computer-readable storage medium may be, but not limited to, an electric, magnetic, optical, electromagnetic, infrared, or semiconductor system, apparatus or device, or any combination thereof. For example, the computer-readable storage medium may include, but not limited to, an electrical connection with one or more wires, a portable computer disk, a hard disk, a random access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to, an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program codes contained on the computer-readable medium may be transmitted by using any suitable medium, including but not limited to, an electric wire, a fiber-optic cable, radio frequency (RF) and the like, or any appropriate combination of them.

In some implementations, the client and the server may communicate with any network protocol currently known or to be researched and developed in the future such as hypertext transfer protocol (HTTP), and may communicate (for example, via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-described computer-readable medium may be included in the above-described electronic device, or may also exist alone without being assembled into the electronic device.

The above-mentioned computer-readable medium carries one or more programs, and the one or more programs, when executed by the electronic device, cause the electronic device to: display a first interaction control, the first interaction control including a plurality of axial directions for a user to select; determine at least one target axial direction in response to a selection operation for any axial direction in the plurality of axial directions; determine an array range of a first target object according to the target axial direction; and array and draw, in response to a determined target array quantity, the first target object according to the target array quantity and the array range.

The computer program codes for performing the operations of the present disclosure may be written in one or more programming languages or a combination thereof. The above-described programming languages include but are not limited to object-oriented programming languages, such as Java, Smalltalk, C++, and also include conventional procedural programming languages, such as the “C” programming language or similar programming languages. The program codes may by executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flow chart and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules and units involved in the embodiments of the present disclosure may be implemented in software or hardware. Here the name of the module or unit does not constitute a limitation of the module or unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), application specific standard parts (ASSP), a system on chip (SOC), a complex programmable logical device (CPLD), etc.

In the context of the present disclosure, the machine-readable medium may be a tangible medium containing or storing a program that can be used by or in combination with an instruction execution system, apparatus or device. The machine-readable medium may be a machine-readable signal medium or a machine-readable storage medium. The machine-readable medium may include, but not limited to, an electric, magnetic, optical, electromagnetic, infrared, or semiconductor system, apparatus or device, or any appropriate combination thereof. Examples of the machine-readable storage medium may include: an electrical connection based on one or more wires, a portable computer disk, a hard disk, a random access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them.

The foregoing are merely descriptions of the preferred embodiments of the present disclosure and the explanations of the technical principles involved. It should be understood by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the scope of the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method actions, it should be understood that the subject matter defined in the appended claims is not necessarily limited to the particular features and actions described above. Rather, the particular features and actions described above are merely exemplary forms for implementing the claims. Regarding the apparatus in the above embodiments, the specific manner in which each module executes operations has been described in detail in the embodiments related to the method, and is not described in detail here.

1. An interaction control method, comprising:
displaying a first interaction control, wherein the first interaction control comprises a plurality of axial directions for a user to select;
determining at least one target axial direction in response to a selection operation for any axial direction in the plurality of axial directions;
determining an array range of a first target object according to the target axial direction; and
arraying and drawing, in response to a determined target array quantity, the first target object according to the target array quantity and the array range.

2. The method according to claim 1, wherein the target array quantity is determined by:
determining, in response to a sliding operation for any axial direction in the target axial direction, a target array quantity in the any axial direction in the target axial direction according to a sliding direction and a sliding distance of the sliding operation.

3. The method according to claim 2, wherein determining, in response to the sliding operation for any axial direction in the target axial direction, the target array quantity in the any axial direction in the target axial direction according to the sliding direction and the sliding distance of the sliding operation comprises:
determining, in response to the sliding operation for a second interaction control corresponding to any axial direction in the target axial direction, the target array quantity in the any axial direction in the target axial direction according to the sliding direction and the sliding distance of the sliding operation.

4. The method according to claim 2, wherein determining the target array quantity in any axial direction in the target axial direction according to the sliding direction and the sliding distance of the sliding operation comprises:
in response to the sliding direction of the sliding operation being a first direction, determining to increase an array quantity in the any axial direction in the target axial direction, and determining, according to the sliding distance corresponding to the sliding operation, a target array quantity to be increased in the any axial direction in the target axial direction in combination with a mapping relationship between the sliding distance and the array quantity; and
in response to the sliding direction of the sliding operation being a second direction, determining to reduce an array quantity in the any axial direction in the target axial direction, and determining, according to the sliding distance corresponding to the sliding operation, a target array quantity to be reduced in the any axial direction in the target axial direction in combination with a mapping relationship between the sliding distance and the array quantity, wherein the second direction is opposite to the first direction.

5. The method according to claim 1, wherein the plurality of axial directions comprise a first axial direction, a second axial direction, and a third axial direction, a virtual scene in which the first target object is located is constructed through the first axial direction, the second axial direction, and the third axial direction, and the first interaction control comprises a first sub-control representing the first axial direction, a second sub-control representing the second axial direction, and a third sub-control representing the third axial direction; and
determining at least one target axial direction in response to the selection operation for any axial direction in the plurality of axial directions comprises:
determining the target axial direction in response to a selection operation for any sub-control among the first sub-control, the second sub-control, and the third sub-control.

6. The method according to claim 1, wherein the plurality of axial directions comprise a first axial direction, a second axial direction, and a third axial direction, and a virtual scene in which the first target object is located is constructed through the first axial direction, the second axial direction, and the third axial direction; and
determining the array range of the first target object according to the target axial direction comprises:
in response to the target axial direction comprising any one axial direction among the first axial direction, the second axial direction, and the third axial direction, determining the array range according to the any one axial direction;
in response to the target axial direction comprising any two axial directions among the first axial direction, the second axial direction, and the third axial direction, determining the array range according to a planar range surrounded by the any two axial directions; and
in response to the target axial direction comprising the first axial direction, the second axial direction, and the third axial direction, determining the array range according to a spatial range surrounded by the first axial direction, the second axial direction, and the third axial direction.

7. The method according to claim 1, further comprising:
displaying an axis of the target axial direction and a control point for adjusting the axis in response to an adjusting operation for the target axial direction;
in response to a moving operation for the control point, moving the control point to obtain a new axis; and
determining a new target axial direction according to the new axis.

8. The method according to claim 1, wherein displaying the first interaction control comprises:
displaying an array control in response to a selection operation for the first target object; and
displaying the first interaction control in response to a selection operation for the array control.

9. The method according to claim 8, wherein displaying the array control in response to the selection operation for the first target object comprises:
in a case of the first target object being an object obtained by arraying a second target object in a virtual scene, in response to the selection operation for the first target object, displaying the array control at the second target object corresponding to the first target object, and deleting the first target object obtained by arraying the second target object.

10. The method according to claim 1, wherein arraying and drawing the first target object comprises:
arraying and drawing the first target object through an instancing method of a graphics processor.

11. The method according to claim 1, further comprising:
in response to a third target object intersecting with a fourth target object in a virtual scene, obtaining a fifth target object according to the third target object and the fourth target object, wherein the third target object is an object obtained by arraying the first target object.

12. The method according to claim 1, further comprising:
in response to the first target object obtained through arraying and drawing satisfying a preset condition, displaying a target line on the first target object obtained through arraying and drawing according to an overall shape of the first target object obtained through arraying and drawing, wherein the target line is used to instruct the user to set an object along the target line.

13. The method according to claim 1, further comprising:
in response to a distance between two adjacent first target objects obtained through arraying and drawing in the target axial direction being less than a preset distance threshold, adjusting a shape of the first target object or the distance to enable the adjusted first target objects to form a whole.

14. An interaction control apparatus, comprising:
a display module, configured to display a first interaction control, wherein the first interaction control comprises a plurality of axial directions for a user to select;
a first determination module, configured to determine at least one target axial direction in response to a selection operation for any axial direction in the plurality of axial directions;
a second determination module, configured to determine an array range of a first target object according to the target axial direction; and
a drawing module, configured to array and draw, in response to a determined target array quantity, the first target object according to the target array quantity and the array range.

15. A computer-readable medium, wherein a computer program is stored on the computer-readable medium, and the computer program, when executed by a processing apparatus, causes the processing apparatus to perform steps of the method according to claim 1.

16. An electronic device, comprising:
a storage apparatus; and
a processing apparatus,
wherein a computer program is stored on the storage apparatus, and the processing apparatus is configured to execute the computer program on the storage apparatus to implement an interaction control method, comprising:
displaying a first interaction control, wherein the first interaction control comprises a plurality of axial directions for a user to select;
determining at least one target axial direction in response to a selection operation for any axial direction in the plurality of axial directions;
determining an array range of a first target object according to the target axial direction; and
arraying and drawing, in response to a determined target array quantity, the first target object according to the target array quantity and the array range.
